(19) United States
(12) Patent Application Publication
(10) Pub. No.: US 2026/0340818 A1
(43) Pub. Date: Oct. 29, 2026

(54) METHODS AND SYSTEMS FOR AUTOMATIC DETECTION AND ANALYSIS OF RECTAL GAS IMPACT ON DIFFUSION-WEIGHTED IMAGING

(71) Applicant: GE Precision Healthcare LLC, Waukesha, WI (US)

(72) Inventors: Dattesh Dayanand Shanbhag, Bengaluru (IN); Vanika Singhal, Bengaluru (IN); Chitresh Bhushan, Schenectady, NY (US); Sudhanya Chatterjee, Bengaluru (IN); Arnaud Guidon, Boston, MA (US); Uday Damodar Patil, Bangalore (IN); Mihir Srivastava, Bengaluru (IN)

(21) Appl. No.: 19/192,186

(22) Filed: Apr. 28, 2025

(51) Int. Cl. G06T 7/00; G06T 7/11; G06T 7/155

(52) U.S. Cl. CPC G06T 7/0012; G06T 7/11; G06T 7/155; G06T 2207/10088; G06T 2207/30081; G06T 2207/30092

(57) ABSTRACT

A method includes acquiring localizer magnetic resonance imaging (MRI) images of a subject, segmenting a prostate gland in the localizer MRI images to create a prostate segmentation mask, determining a region of interest (ROI) around the prostate gland, applying contrast normalization to standardize the localizer MRI images, segmenting rectal gas regions within the ROI around the prostate gland, calculating morphological parameters based on the prostate segmentation mask and the rectal gas regions, determining acquisition parameters for diffusion-weighted imaging (DWI), predicting a DWI distortion probability based on the morphological parameters and the acquisition parameters, and generating an alert to a technologist about potential DWI artifacts when the DWI distortion probability exceeds a threshold value. The automated detection and analysis of rectal gas enables technologists to take corrective action before DWI acquisition, reducing the need for repeat examinations and improving diagnostic quality of prostate MRI studies.

### TECHNICAL FIELD

Embodiments of the subject matter disclosed herein relate to medical imaging, and more particularly, to magnetic resonance imaging (MRI).

### BACKGROUND

In magnetic resonance imaging (MRI) systems, a subject is positioned within a strong magnetic field and exposed to radiofrequency (RF) pulses that cause hydrogen atoms in the subject's tissues to emit signals. These signals are detected and processed to generate images of the subject's internal structures. Diffusion-weighted imaging (DWI) is a specialized MRI technique that measures the random Brownian motion of water molecules within tissues, providing valuable diagnostic information particularly for oncological applications such as prostate cancer detection and characterization.

Prostate MRI exams typically follow Prostate Imaging-Reporting and Data System (PI-RADS) guidelines, which recommend the use of DWI along with T2-weighted (T2W) and dynamic contrast-enhanced (DCE) imaging for detection and risk scoring of prostate cancer. This requires that DWI data should be of sufficiently good quality to facilitate reading and subsequent risk scoring by radiologists. However, various factors can degrade DWI image quality, with rectal gas being a significant concern.

Rectal gas may cause susceptibility artifacts in echo-planar imaging (EPI) DWI images of the prostate, leading to image distortion and signal dropout. These artifacts occur at the air-tissue interface, making it challenging to accurately assess and study prostate tumors. Multiple studies have highlighted this issue, noting that the presence of rectal gas can render DWI sequences non-diagnostic or significantly impair their interpretability. When DWI sequences are compromised by rectal gas artifacts, radiologists may be unable to properly evaluate the prostate peripheral zone, potentially leading to missed lesions or inaccurate characterization of identified abnormalities.

Current approaches to address this issue are limited. Some facilities employ patient preparation protocols such as administering laxatives or enemas prior to scanning, but these measures are not always effective and may be uncomfortable for patients. During scanning, technologists must manually review images to identify problematic rectal gas, which requires experience and may interrupt workflow. In some commercial systems, technologists are prompted to manually indicate if rectal gas is suspected, but this approach still relies on human judgment and does not provide automated analysis of the potential impact on image quality. Furthermore, rectal gas can move during the examination due to natural peristalsis. Gas that was not present during initial localizer scans may move into the rectum during subsequent sequences, potentially affecting DWI quality. This temporal variability adds another layer of complexity to managing rectal gas-induced artifacts.

When DWI sequences are compromised by rectal gas artifacts, the examination may need to be repeated, leading to increased scan time, reduced patient throughput, additional costs, and patient inconvenience. In some cases, patients may need to return for a repeat examination on another day, further delaying diagnosis and treatment. Therefore, there remains an unmet need for an automated system that can detect rectal gas, analyze its potential impact on DWI image quality, and alert technologists before DWI acquisition, allowing for timely intervention and optimization of scan parameters. Such a system would improve workflow efficiency, reduce the need for repeat examinations, and ultimately enhance the diagnostic quality of prostate MRI studies.

### SUMMARY

In one example, a method includes acquiring localizer MRI images of a subject, segmenting a prostate gland in the localizer MRI images to create a prostate segmentation mask, determining a region of interest (ROI) around the prostate gland, applying contrast normalization to standardize the localizer MRI images, segmenting rectal gas regions within the ROI around the prostate gland, calculating morphological parameters based on the prostate segmentation mask and the rectal gas regions, determining acquisition parameters for DWI, predicting a DWI distortion probability based on the morphological parameters and the acquisition parameters, generating an alert to a technologist about potential DWI artifacts when the DWI distortion probability exceeds a threshold value, automatically adjusting scan parameters when the DWI distortion probability exceeds the threshold value, and acquiring a medical image based on the adjusted scan parameters.

In another example, a system includes one or more processors and non-transitory memory storing instructions executable by the one or more processors to obtain initial localizer MRI images of a subject, segment a prostate gland in the initial localizer MRI images, determine an ROI around the segmented prostate gland, apply contrast normalization to standardize the initial localizer MRI images, segment rectal gas regions within the ROI around the prostate gland, selectively filter the segmented rectal gas regions, calculate morphological parameters based on the segmented prostate gland and the segmented rectal gas regions, determine acquisition parameters for DWI, predict a DWI distortion probability based on the morphological parameters and the acquisition parameters, and generate an alert to a technologist when the predicted DWI distortion probability exceeds a threshold value.

In yet another example, a method for predicting DWI distortion in prostate MRI includes acquiring localizer MRI images of a subject, segmenting a prostate gland in the localizer MRI images using a deep learning-based model to create a prostate segmentation mask, determining an ROI extending a predetermined distance from the prostate segmentation mask in multiple directions, applying contrast normalization to remove radiofrequency bias in the localizer MRI images, calculating an average signal intensity in the ROI around the prostate gland, setting a gas threshold as a proportion of the average signal intensity, identifying pixels within the ROI having normalized signal intensity below the gas threshold to create a binary gas mask, applying connected component analysis to remove gas regions smaller than a pre-determined size, calculating a minimum surface distance between remaining gas regions and the prostate gland, calculating a total gas volume within the ROI, retrieving acquisition parameters for a planned DWI sequence, encoding the minimum surface distance, the total gas volume, and the acquisition parameters as input features for a predictive model, applying the predictive model to generate a probability of DWI distortion, and displaying an alert on a display device when the probability of DWI distortion exceeds a threshold value.

The above approaches provide several advantages over current techniques. By automatically detecting and analyzing rectal gas before DWI acquisition, the system enables technologists to take corrective action through patient preparation or DWI acquisition parameter adjustments. This reduces the need for repeat examinations, which can lead to increased scan time, reduced patient throughput, additional costs, and patient inconvenience. The automated nature of the detection system eliminates reliance on human judgment and experience, providing consistent assessment of potential DWI distortion across different operators and facilities. Furthermore, by analyzing both morphological parameters (such as gas volume and distance from prostate) and acquisition parameters, the system provides a more accurate prediction of potential artifacts than visual inspection alone. The use of deep learning-based models for prostate segmentation and connected component analysis for filtering gas regions further enhances the accuracy and reliability of the prediction. This ultimately improves workflow efficiency, enhances the diagnostic quality of prostate MRI studies, and increases the likelihood that DWI sequences will be of sufficient quality to facilitate proper reading and risk scoring according to PI-RADS guidelines.

The above advantages and other advantages, and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 is a schematic diagram illustrating an imaging system for acquiring MRI, according to an embodiment of the present disclosure;

FIG. 2 is a block diagram illustrating an image processing device, according to an embodiment of the present disclosure;

FIG. 3 shows a flow chart illustrating a method for automatic detection and analysis of rectal gas impact on diffusion-weighted imaging, according to embodiments of the present disclosure;

FIG. 4 shows a flow chart illustrating a method for segmenting rectal gas regions within a region of interest around a prostate gland, according to embodiments of the present disclosure;

FIG. 5 shows a flow chart illustrating a method for calculating morphological parameters based on a prostate segmentation mask and segmented gas regions, according to embodiments of the present disclosure;

FIG. 6 shows a flow chart illustrating a method for managing MRI scan protocols based on gas analysis and distortion probability, according to embodiments of the present disclosure;

FIG. 7 shows a visual representation of a contrast normalization process for enhancing medical images, according to embodiments of the present disclosure;

FIG. 8 shows a visualization of a prostate segmentation process showing the transformation from an input medical image to a segmented output image, according to embodiments of the present disclosure;

FIG. 9 shows a comparison of anatomical scan images before and after gas segmentation processing, according to embodiments of the present disclosure; and

FIG. 10 shows a medical imaging visualization showing ROI selection, according to embodiments of the present disclosure.

### DETAILED DESCRIPTION

The following description relates to automatic detection and analysis of rectal gas impact on diffusion-weighted imaging (DWI). In particular, the following description relates to methods and systems for automatically detecting rectal gas in localizer magnetic resonance imaging (MRI) images, analyzing its potential impact on DWI quality, and providing timely alerts to technologists before DWI acquisition to enable corrective actions.

Rectal gas can cause significant susceptibility artifacts in echo-planar imaging (EPI) DWI sequences of the prostate, leading to image distortion and signal dropout at the air-tissue interface. These artifacts can render DWI sequences non-diagnostic or significantly impair their interpretability, potentially leading to missed lesions or inaccurate characterization of identified abnormalities. Current approaches to address this issue are limited, often relying on manual review of images by technologists to identify problematic rectal gas, which requires experience and may interrupt workflow. When DWI sequences are compromised by rectal gas artifacts, examinations may need to be repeated, leading to increased scan time, reduced patient throughput, additional costs, and patient inconvenience.

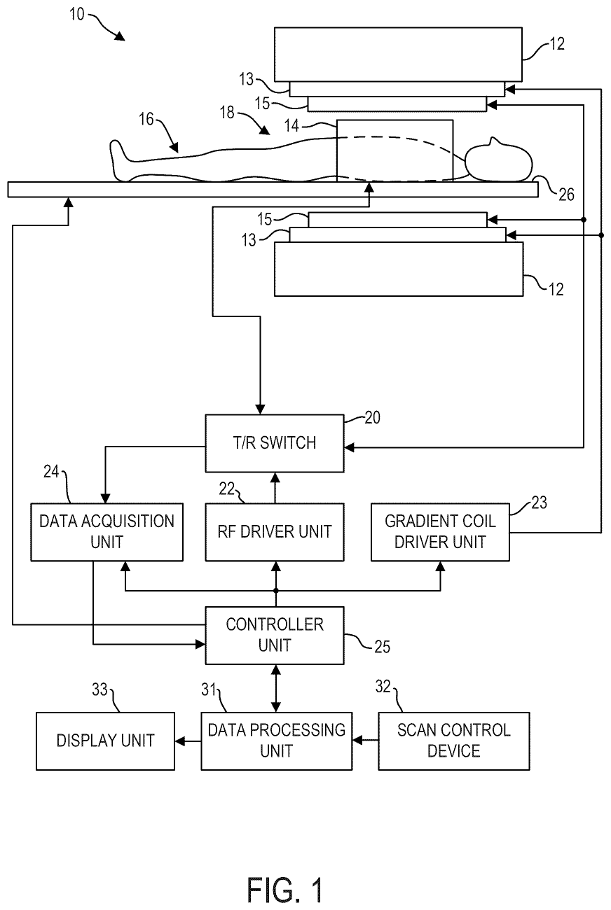

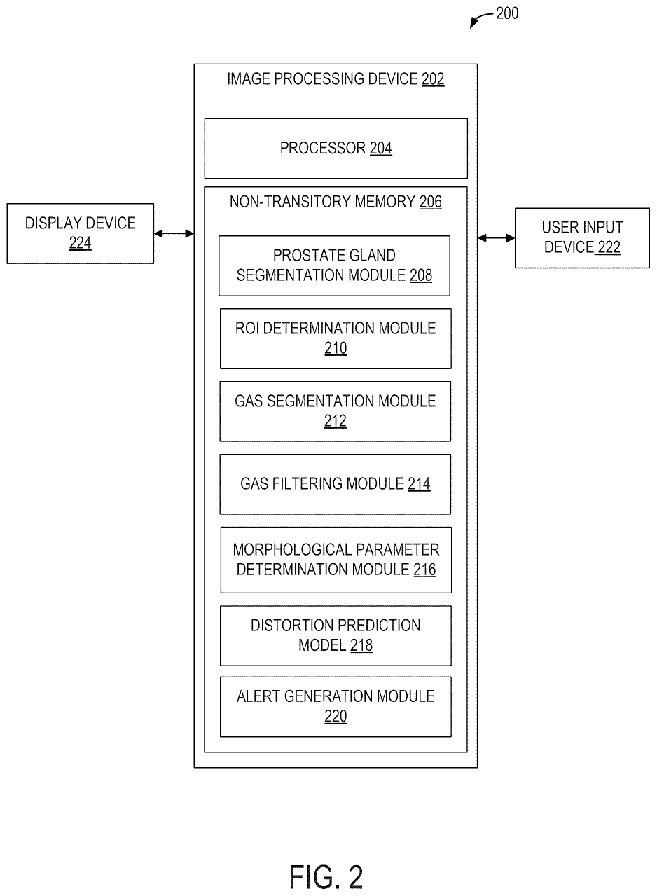

In one embodiment, MRI images may be acquired using an MRI imaging system, such as MRI system 10 shown in FIG. 1. The MRI system 10 includes a magnetostatic field magnet unit 12, gradient coil unit 13, RF coil units 14 and 15, and other components for acquiring MRI data of a subject positioned within imaging space 18. The acquired MRI data may be processed via an image processing system 200, shown in FIG. 2, which includes an image processing device 202 with a processor 204 and non-transitory memory 206 storing various processing modules for analyzing prostate gland images and predicting distortion.

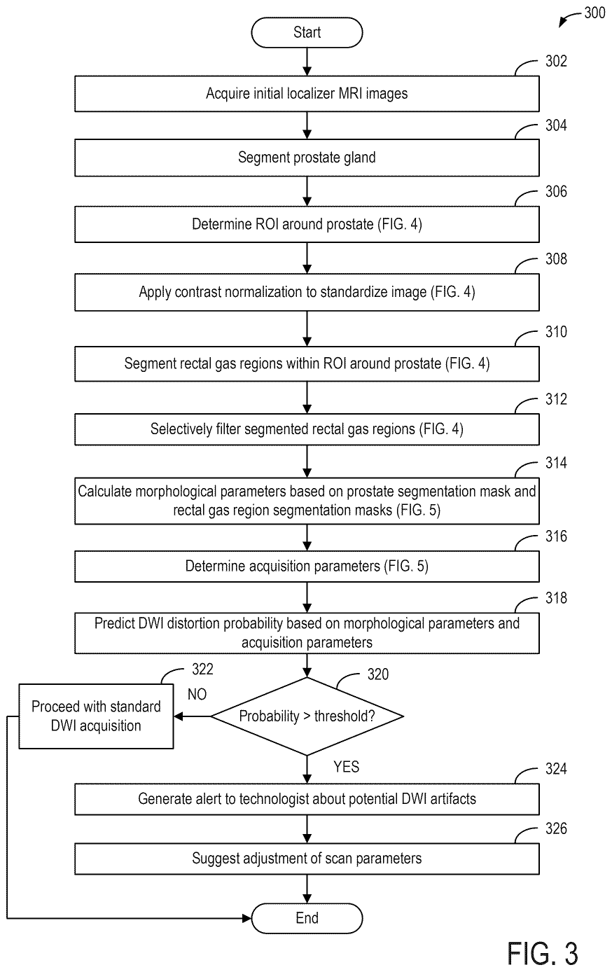

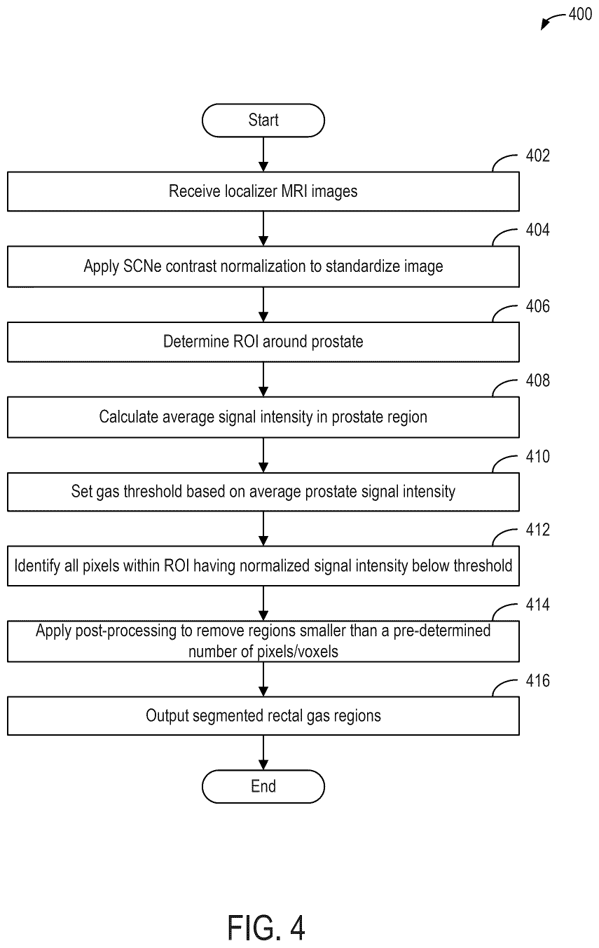

The image processing system 200 may execute one or more operations of method 300, shown in FIG. 3, which illustrates a workflow for automatic detection and analysis of rectal gas impact on DWI. Method 300 includes acquiring localizer MRI images, segmenting the prostate gland, determining an ROI around the prostate, applying contrast normalization, segmenting rectal gas regions, calculating morphological parameters, determining acquisition parameters, predicting DWI distortion probability, and generating alerts when necessary. The gas segmentation portion of method 300 is detailed in FIG. 4, which shows a process for segmenting rectal gas regions within the ROI around the prostate, including applying contrast normalization, determining the ROI, calculating average signal intensity, setting a gas threshold, identifying pixels below the threshold, and applying post-processing to remove small regions of detected gas.

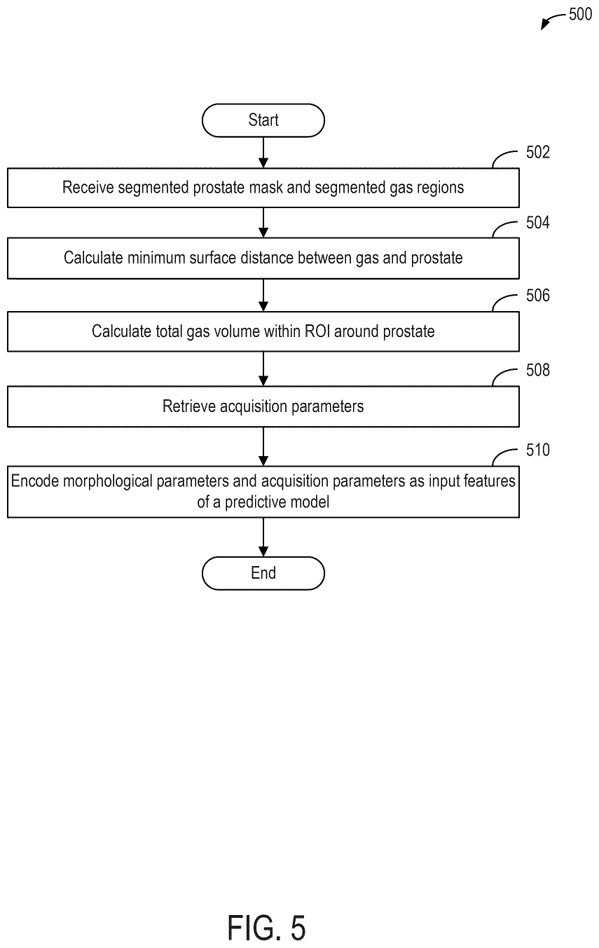

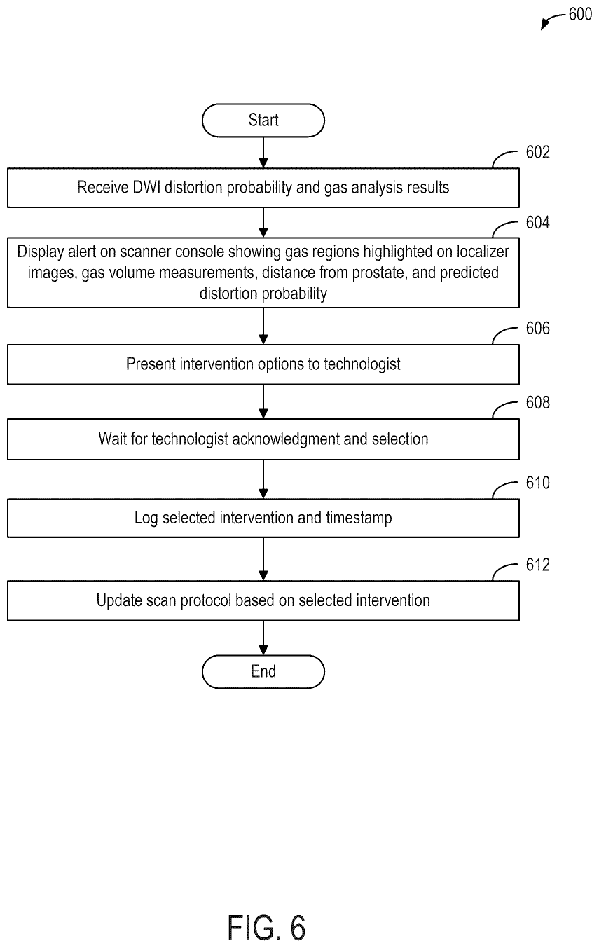

Once gas regions are segmented, the system calculates morphological parameters as shown in FIG. 5, which illustrates the process for calculating parameters based on the prostate segmentation mask and segmented gas regions, including calculating minimum surface distance between gas and prostate, calculating total gas volume, retrieving acquisition parameters, and encoding these parameters as input features for a predictive model. Based on the predicted distortion probability, the system may implement the protocol management workflow shown in FIG. 6, which illustrates a method for managing MRI scan protocols based on gas analysis and distortion probability, including receiving DWI distortion probability results, displaying alerts with highlighted gas regions, presenting intervention options to technologists, and updating scan protocols based on selected interventions.

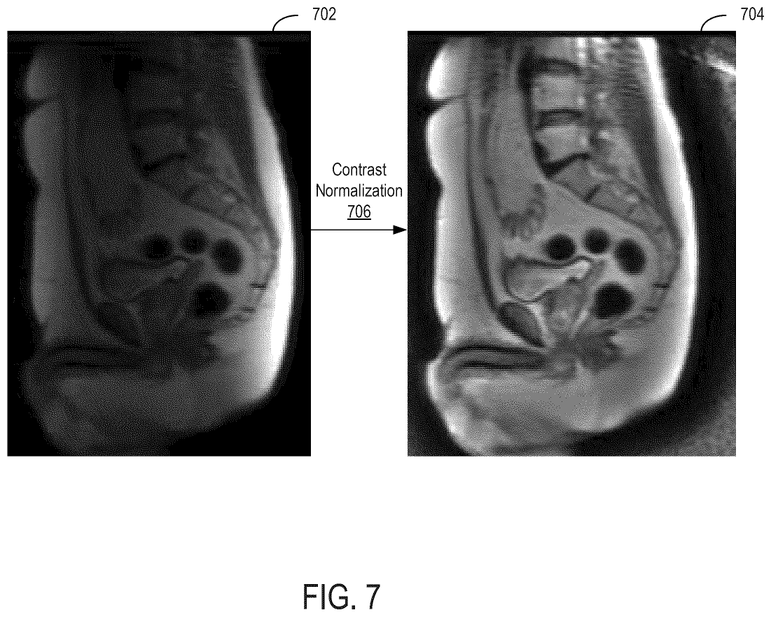

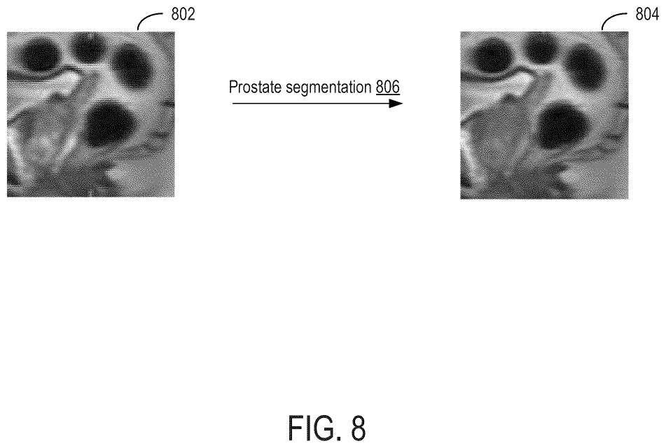

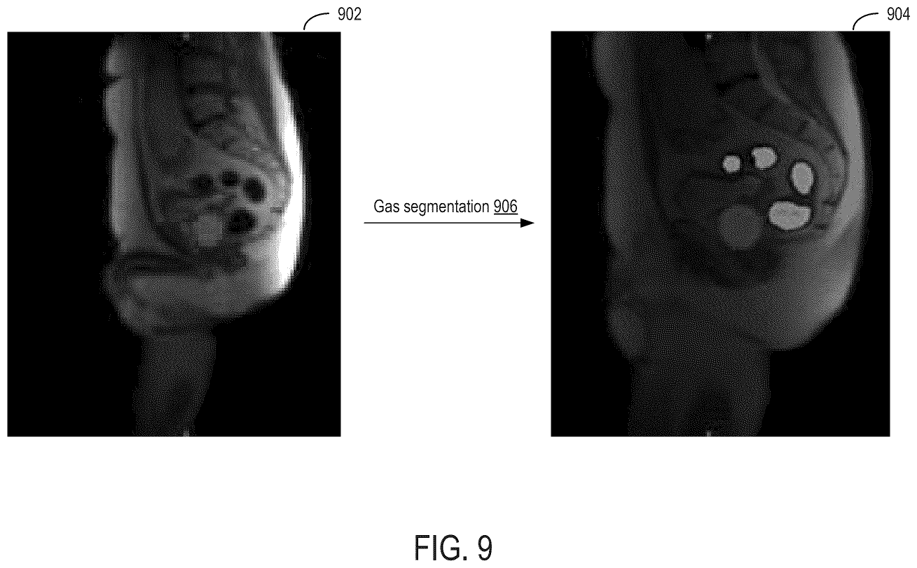

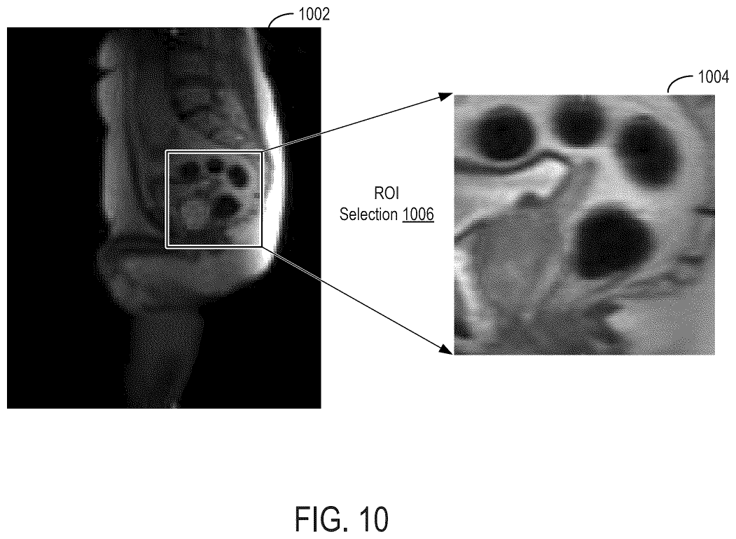

The contrast normalization process applied in methods 300 and 400 is visually represented in FIG. 7, which demonstrates the transformation from an initial medical image to a contrast-normalized medical image with standardized intensity values that facilitate more reliable gas segmentation. FIG. 8 shows a visualization of the prostate segmentation process referenced in method 300, illustrating how a deep learning-based model transforms an input medical image into a segmented output image with the prostate gland highlighted. FIG. 9 shows a comparison of anatomical scan images before and after gas segmentation processing, demonstrating how the gas segmentation process identifies rectal gas regions that could potentially cause susceptibility artifacts in DWI sequences. Finally, FIG. 10 shows a medical imaging visualization with ROI selection, including a full anatomical view image containing a highlighted ROI and a magnified view of this region showing detailed segmentation of the prostate and any detected rectal gas regions.

This automated approach addresses the limitations of existing methods by providing a system that can detect rectal gas, analyze its potential impact on DWI image quality, and alert technologists before DWI acquisition, allowing for timely intervention and adjustment of scan parameters. By analyzing both morphological parameters (such as gas volume and distance from prostate) and acquisition parameters, the system provides a more accurate prediction of potential artifacts than visual inspection alone. This ultimately improves workflow efficiency, reduces the need for repeat examinations, and enhances the diagnostic quality of prostate MRI studies, increasing the likelihood that DWI sequences will be of sufficient quality to facilitate proper reading and risk scoring according to PI-RADS guidelines.

Referring first to FIG. 1, an MRI apparatus 10 is shown, that includes a magnetostatic field magnet unit 12, a gradient coil unit 13, an RF coil unit 14, an RF body coil unit 15 (e.g., image coil unit), a transmit/receive (T/R) switch 20, an RF driver unit 22, a gradient coil driver unit 23, a data acquisition unit 24, a controller unit 25, a patient bed or table 26, a data processing unit 31, a scan control device 32, and a display unit 33. In some embodiments, the RF coil unit 14 is a surface coil, which is a local coil typically placed proximate to the anatomy of interest of a subject 16. Herein, the RF body coil unit 15 is a transmit coil that transmits RF signals, and the local surface of the RF coil unit 14 receives the MR signals. As such, the transmit body coil (e.g., RF body coil unit 15) and the surface receive coil (e.g., RF coil unit 14) are separate but electromagnetically coupled components. The MRI apparatus 10 transmits electromagnetic pulse signals to the subject 16 placed in an imaging space 18 with a static magnetic field formed to perform a scan for obtaining magnetic resonance signals from the subject 16. One or more images of the subject 16 can be reconstructed based on the magnetic resonance signals thus obtained by the scan.

The magnetostatic field magnet unit 12 includes, for example, an annular superconducting magnet, which is mounted within a toroidal vacuum vessel. The magnet defines a cylindrical space surrounding the subject 16 and generates a constant primary magnetostatic field B₀.

The MRI apparatus 10 also includes a gradient coil unit 13 that forms a gradient magnetic field in the imaging space 18 so as to provide the magnetic resonance signals received by the RF coil arrays with three-dimensional positional information. The gradient coil unit 13 includes three gradient coil systems, each of which generates a gradient magnetic field along one of three spatial axes perpendicular to each other, and generates a gradient field in each of a frequency encoding direction, a phase encoding direction, and a slice selection direction in accordance with the imaging condition. More specifically, the gradient coil unit 13 applies a gradient field in the slice selection direction (or scan direction) of the subject 16, to select the slice; and the RF body coil unit 15 or the local RF coil arrays may transmit an RF pulse to a selected slice of the subject 16. The gradient coil unit 13 also applies a gradient field in the phase encoding direction of the subject 16 to phase encode the magnetic resonance signals from the slice excited by the RF pulse. The gradient coil unit 13 then applies a gradient field in the frequency encoding direction of the subject 16 to frequency encode the magnetic resonance signals from the slice excited by the RF pulse.

The RF coil unit 14 is disposed, for example, to enclose the region to be imaged of the subject 16. In some examples, the RF coil unit 14 may be referred to as the surface coil or the receive coil. In the static magnetic field space or imaging space 18 where a static magnetic field B₀ is formed by the magnetostatic field magnet unit 12, the RF body coil unit 15 transmits, based on a control signal from the controller unit 25, an RF pulse that is an electromagnet wave to the subject 16 and thereby generates a high-frequency magnetic field B₁. This excites a spin of protons in the slice to be imaged of the subject 16. The RF coil unit 14 receives, as a magnetic resonance signal, the electromagnetic wave generated when the proton spin thus excited in the slice to be imaged of the subject 16 returns into alignment with the initial magnetization vector. In some embodiments, the RF coil unit 14 may transmit the RF pulse and receive the MR signal. In other embodiments, the RF coil unit 14 may only be used for receiving the MR signals, but not transmitting the RF pulse.

The RF body coil unit 15 is disposed, for example, to enclose the imaging space 18, and produces RF magnetic field pulses orthogonal to the main magnetic field B₀ produced by the magnetostatic field magnet unit 12 within the imaging space 18 to excite the nuclei. In contrast to the RF coil unit 14, which may be disconnected from the MRI apparatus 10 and replaced with another RF coil unit, the RF body coil unit 15 is fixedly attached and connected to the MRI apparatus 10. Furthermore, whereas local coils such as the RF coil unit 14 can transmit to or receive signals from only a localized region of the subject 16, the RF body coil unit 15 generally has a larger coverage area. The RF body coil unit 15 may be used to transmit or receive signals to the whole body of the subject 16, for example. Using receive-only local coils and transmit body coils provides a uniform RF excitation and good image uniformity at the expense of high RF power deposited in the subject. For a transmit-receive local coil, the local coil provides the RF excitation to the region of interest and receives the MR signal, thereby decreasing the RF power deposited in the subject. It should be appreciated that the particular use of the RF coil unit 14 and/or the RF body coil unit 15 depends on the imaging application.

The T/R switch 20 can selectively electrically connect the RF body coil unit 15 to the data acquisition unit 24 when operating in receive mode, and to the RF driver unit 22 when operating in transmit mode. Similarly, the T/R switch 20 can selectively electrically connect the RF coil unit 14 to the data acquisition unit 24 when the RF coil unit 14 operates in receive mode, and to the RF driver unit 22 when operating in transmit mode. When the RF coil unit 14 and the RF body coil unit 15 are both used in a single scan, for example if the RF coil unit 14 is configured to receive MR signals and the RF body coil unit 15 is configured to transmit RF signals, then the T/R switch 20 may direct control signals from the RF driver unit 22 to the RF body coil unit 15 while directing received MR signals from the RF coil unit 14 to the data acquisition unit 24. The coils of the RF body coil unit 15 may be configured to operate in a transmit-only mode or a transmit-receive mode. The coils of the RF coil unit 14 may be configured to operate in a transmit-receive mode or a receive-only mode.

The RF driver unit 22 includes a gate modulator, an RF power amplifier (not shown), and an RF oscillator (not shown) that are used to drive the RF coils (e.g., RF body coil unit 15) and form a high-frequency magnetic field in the imaging space 18. The RF driver unit 22 modulates, based on a control signal from the controller unit 25 and using the gate modulator, the RF signal received from the RF oscillator into a signal of predetermined timing having a predetermined envelope. The RF signal modulated by the gate modulator is amplified by the RF power amplifier and then output to the RF body coil unit 15.

The gradient coil driver unit 23 drives the gradient coil unit 13 based on a control signal from the controller unit 25 and thereby generates a gradient magnetic field in the imaging space 18. The gradient coil driver unit 23 includes three systems of driver circuits (not shown) corresponding to the three gradient coil systems included in the gradient coil unit 13.

The data acquisition unit 24 includes a pre-amplifier, a phase detector, and an analog/digital converter used to acquire the magnetic resonance signals received by the RF coil unit 14. In the data acquisition unit 24, the phase detector phase detects, using the output from the RF oscillator of the RF driver unit 22 as a reference signal, the magnetic resonance signals received from the RF coil unit 14 and amplified by the pre-amplifier, and outputs the phase-detected analog magnetic resonance signals to the analog/digital converter for conversion into digital signals. The digital signals thus obtained are output to the data processing unit 31.

The MRI apparatus 10 includes a table 26 for placing the subject 16 thereon. The subject 16 may be moved inside and outside the imaging space 18 by moving the table 26 based on control signals from the controller unit 25.

The controller unit 25 includes a computer and a non-transitory computer-readable storage medium on which computer-executable instructions are stored. When executed by the computer, the instructions cause various components of the apparatus 10 to carry out operations corresponding to predetermined scanning protocols. The non-transitory computer-readable storage medium may comprise one or more of a solid-state drive (SSD), a hard disk drive (HDD), a hybrid drive, an optical disc (e.g., CD, DVD, Blu-ray), a flash memory device, a random access memory (RAM) device, a read-only memory (ROM) device, or any other suitable non-transitory storage medium. In some embodiments, the non-transitory computer-readable storage medium may be a cloud-based or network-attached storage system accessible by the controller unit 25 over a wired or wireless network connection.

The controller unit 25 is connected to the scan control device 32 and processes the operation signals input to the scan control device 32 and furthermore controls the table 26, RF driver unit 22, gradient coil driver unit 23, and data acquisition unit 24 by outputting control signals to them. The controller unit 25 also controls, to obtain a desired image, the data processing unit 31 and the display unit 33 based on operation signals received from the scan control device 32.

The scan control device 32 includes user input devices such as a touchscreen, keyboard and a mouse. The scan control device 32 is used by an operator, for example, to input such data as an imaging protocol and to set a region where an imaging sequence is to be executed. The data about the imaging protocol and the imaging sequence execution region are output to the controller unit 25.

The data processing unit 31 includes a computer and a recording medium on which a program to be executed by the computer to perform predetermined data processing is recorded. The data processing unit 31 is connected to the controller unit 25 and performs data processing based on control signals received from the controller unit 25. The data processing unit 31 is also connected to the data acquisition unit 24 and generates spectrum data by applying various image processing operations to the magnetic resonance signals output from the data acquisition unit 24. In some embodiments, the data processing unit 31 includes a rectal gas detection and analysis module configured to automatically detect and analyze rectal gas in prostate MRI scans. The rectal gas detection and analysis module may include a prostate gland segmentation component, a rectal gas segmentation component, and a distortion prediction component that utilizes a machine learning model to predict the probability of distortion in diffusion-weighted imaging (DWI) based on parameters such as the minimum distance between gas pockets and the prostate, gas volume, and acquisition parameters.

The display unit 33 includes a display device and displays an image on the display screen of the display device based on control signals received from the controller unit 25. The display unit 33 displays, for example, an image regarding an input item about which the operator inputs operation data from the scan control device 32. The display unit 33 also displays a two-dimensional (2D) slice image or three-dimensional (3D) image of the subject 16 generated by the data processing unit 31. In some embodiments, the display unit 33 is configured to display warning messages to the operator regarding the presence of rectal gas and its potential impact on DWI image quality, allowing the operator to take corrective action before proceeding with the DWI acquisition.

During an MRI scan using the MRI apparatus 10, a subject may be positioned within the imaging space 18 and an acquisition protocol may be carried out to obtain MR signals of the subject. The acquisition protocol may include a plurality of pulse sequences where in each pulse sequence, contrast is prepared via one or more RF pulses applied by the RF body coil unit 15 and the gradient coil unit 13 is controlled to spatially encode the resultant MR signals. The spatially-encoded MR signals are received by the RF coil unit 14 are digitized and stored in k-space. Thus, k-space data or a k-space dataset may refer to the raw MR signals prior to processing into an image. In some examples, one line of k-space may be filled with the raw MR signals per pulse sequence (also referred to as repetition time). In other examples, one line of k-space may be filled with the raw MR signals per echo, where more than one echo is generated per pulse sequence/repetition time. The k-space data may also be referred to as imaging data or MR data herein.

For prostate imaging applications, the MRI apparatus 10 may be configured to perform diffusion-weighted imaging (DWI) sequences that are particularly sensitive to susceptibility artifacts caused by rectal gas. The controller unit 25 and data processing unit 31 may be configured to implement an automated workflow to predict and mitigate the impact of rectal gas on DWI image quality. This workflow may utilize three-plane localizer images acquired during scan planning to detect rectal gas, determine its proximity to the prostate gland, and assess its potential impact on DWI image quality. The workflow may include segmenting the prostate gland, localizing regions around the prostate where rectal gas could cause significant impact, segmenting rectal gas within these regions, and analyzing various parameters that affect distortion in echo-planar imaging (EPI) DWI sequences. Based on this analysis, the system may provide warnings to the operator and suggest appropriate corrective actions or alternative acquisition schemes to minimize artifacts and ensure diagnostic image quality.

Referring to FIG. 2, an image processing system 200 for analyzing prostate gland images and predicting distortion is shown. The image processing system 200 is configured to automatically detect rectal gas in localizer MRI images, analyze its potential impact on DWI quality, and provide timely alerts to technologists before DWI acquisition to enable corrective actions. The image processing system 200 may be incorporated into an MRI system, such as the MRI apparatus shown in FIG. 1, or may be provided as a separate system communicably coupled to the MRI system via wired and/or wireless connections. In some embodiments, at least a portion of the image processing system 200 is disposed at a separate device (e.g., a workstation) which can receive MRI data from the MRI system or from a storage device which stores the MRI data generated by the MRI system.

The image processing system 200 includes an image processing device 202 having a processor 204 configured to execute machine readable instructions stored in non-transitory memory 206. The processor 204 may be single core or multi-core, and the programs executed thereon may be configured for parallel or distributed processing. In some embodiments, the processor 204 may optionally include individual components that are distributed throughout two or more devices, which may be remotely located and/or configured for coordinated processing. In some embodiments, one or more aspects of processor 204 may be virtualized and executed by remotely-accessible networked computing devices configured in a cloud computing configuration. The processor 204 is communicatively coupled to the non-transitory memory 206, a display device 224, and a user input device 222, and is configured to execute the various modules stored in the non-transitory memory 206 to perform the automatic detection and analysis of rectal gas impact on DWI.

The non-transitory memory 206 stores machine readable instructions that, when executed by the processor 204, cause the image processing device 202 to perform various operations related to the automatic detection and analysis of rectal gas impact on DWI. In one embodiment, the non-transitory memory 206 stores a prostate gland segmentation module 208, an ROI determination module 210, a gas segmentation module 212, a gas filtering module 214, a morphological parameter determination module 216, a distortion prediction model 218, and an alert generation module 220. In another embodiment, the non-transitory memory 206 may also store MRI data, including localizer MRI images, segmentation masks, and other data generated during the processing of the MRI images. The non-transitory memory 206 may further store training data for one or more machine learning models used in the various modules, such as deep learning-based models for prostate segmentation and gas detection.

The display device 224 may include one or more display devices utilizing virtually any type of technology. In one embodiment, the display device 224 may comprise a computer monitor, and may display MRI images, including localizer images, segmentation results, and alerts generated by the alert generation module 220. In another embodiment, the display device 224 may be integrated into an MRI system, such as at the display unit of the MRI system shown in FIG. 1. The display device 224 may be combined with the processor 204, non-transitory memory 206, and/or user input device 222 in a shared enclosure, or may be a peripheral display device and may comprise a monitor, touchscreen, projector, or other display device known in the art, which may enable a user to view MRI images produced by an MRI system, and/or interact with various data stored in the non-transitory memory 206.

The user input device 222 may comprise one or more of a touchscreen, a keyboard, a mouse, a trackpad, or other device configured to enable a user to interact with and manipulate data within the image processing system 200. In one embodiment, the user input device 222 may enable a user to make a selection of MRI data to use in analyzing rectal gas impact on DWI, or for further processing using the various modules stored in the non-transitory memory 206. In another embodiment, the user input device 222 may enable a user to acknowledge alerts generated by the alert generation module 220 and select appropriate corrective actions, such as administering a micro-enema to reduce rectal gas or switching to a more robust DWI acquisition scheme.

The prostate gland segmentation module 208 is configured to segment a prostate gland in localizer MRI images to create a prostate segmentation mask. In one embodiment, the prostate gland segmentation module 208 may include a deep learning-based model specifically developed for prostate segmentation on sagittal and coronal localizers. The segmentation model may output a binary mask identifying the prostate region within the localizer images. In another embodiment, the prostate gland segmentation module 208 may leverage existing prostate segmentation models, such as those used in automated scan planning systems, to identify the boundaries of the prostate gland. The prostate gland segmentation module 208 provides the prostate segmentation mask to the ROI determination module 210 and the morphological parameter determination module 216 for further processing.

The ROI determination module 210 is configured to determine a region of interest (ROI) around the prostate gland based on the prostate segmentation mask generated by the prostate gland segmentation module 208. In one embodiment, the ROI may be defined as extending a predetermined distance from the prostate segmentation mask in multiple directions, such as 50 mm superiorly, 20 mm inferiorly, 10 mm anteriorly, and 80 mm posteriorly. This ROI focuses the subsequent analysis on the area most likely to contain rectal gas that could affect DWI quality. In another embodiment, the ROI may be dynamically determined based on the size and position of the prostate gland, adjusting the extension distances proportionally to ensure adequate coverage of the rectal area adjacent to the prostate. The ROI determination module 210 provides the determined ROI to the gas segmentation module 212 for use in segmenting rectal gas regions.

The gas segmentation module 212 is configured to segment rectal gas regions within the ROI around the prostate gland. In one embodiment, the gas segmentation module 212 may apply standardized contrast normalization (SCNe) to the localizer MRI images to remove radiofrequency (RF) bias and standardize the threshold for subsequent segmentation steps. The gas regions may then be identified by applying a threshold to the normalized signal intensity, where pixels with normalized intensity below a certain threshold (e.g., 0.3 times the average prostate signal intensity) are classified as gas. In another embodiment, the gas segmentation module 212 may employ a convolutional neural network (CNN) to perform the gas segmentation, potentially providing improved resilience to segmentation errors and better adaptation to various image characteristics. The gas segmentation module 212 provides the segmented gas regions to the gas filtering module 214 for further processing.

The gas filtering module 214 is configured to selectively filter the segmented rectal gas regions identified by the gas segmentation module 212. In one embodiment, the gas filtering module 214 may apply post-processing to remove regions smaller than a pre-determined number of pixels or voxels (e.g., 100 voxels), as these small regions are less likely to cause significant DWI distortion and may represent noise or segmentation errors. This filtering step helps focus the analysis on gas pockets large enough to potentially impact image quality. In another embodiment, the gas filtering module 214 may apply morphological operations such as erosion and dilation to refine the gas region boundaries and connect nearby gas pockets that likely represent a single continuous gas region. The gas filtering module 214 provides the filtered gas regions to the morphological parameter determination module 216 for further analysis.

The morphological parameter determination module 216 is configured to calculate morphological parameters based on the prostate segmentation mask and the filtered gas regions. In one embodiment, the morphological parameters may include the minimum surface distance between the gas regions and the prostate gland, calculated using distance transform techniques such as the Hausdorff distance. Additionally, the total gas volume within the ROI may be calculated by summing the volumes of all identified gas regions. In another embodiment, the morphological parameter determination module 216 may calculate additional morphological parameters, such as the shape and orientation of gas pockets relative to the prostate, or the percentage of the prostate's posterior surface that is adjacent to gas. The morphological parameter determination module 216 provides the calculated morphological parameters to the distortion prediction model 218 for predicting DWI distortion probability.

The distortion prediction model 218 is configured to predict a DWI distortion probability based on the morphological parameters calculated by the morphological parameter determination module 216 and acquisition parameters for the DWI sequence. In one embodiment, the distortion prediction model 218 may include a multivariate logistic regression model trained on a dataset of cases with known DWI distortion outcomes. The model may use inputs such as minimum surface distance between gas and prostate and total gas volume. In another embodiment, the distortion prediction model 218 may employ a machine learning model, such as a random forest or neural network, to capture non-linear relationships between the input parameters and the likelihood of distortion. The distortion prediction model 218 provides the predicted DWI distortion probability to the alert generation module 220 for determining whether to generate an alert.

The alert generation module 220 is configured to generate an alert to a technologist about potential DWI artifacts when the DWI distortion probability predicted by the distortion prediction model 218 exceeds a threshold value. In one embodiment, the threshold may be determined through receiver operating characteristic (ROC) analysis of the prediction model's performance on a validation dataset, with a cutoff value (e.g., >0.52) selected to balance sensitivity and specificity. If the predicted probability exceeds the threshold value, the alert generation module 220 may display an alert prominently on the display device 224, highlighting the areas of rectal gas on the localizer images and indicating the high probability of DWI distortion. In another embodiment, the alert generation module 220 may also suggest optimization of scan parameters to mitigate the potential artifacts, such as administering a micro-enema to reduce rectal gas before proceeding with the scan, or switching to a more robust DWI acquisition scheme, such as PROPELLER diffusion-weighted imaging, which is less susceptible to susceptibility artifacts.

Referring to FIG. 3, a flowchart of a method 300 for predicting and managing diffusion-weighted imaging (DWI) distortion in prostate MRI is shown. The method 300 provides an automated approach for detecting rectal gas, analyzing its potential impact on DWI image quality, and alerting technologists before DWI acquisition to enable timely intervention and optimization of scan parameters. The method 300 begins with acquiring initial localizer MRI images and proceeds through various processing steps to predict the probability of DWI distortion, ultimately providing appropriate alerts and suggestions to the technologist when necessary.

At operation 302, the method includes acquiring initial localizer MRI images of a subject. In one embodiment, the initial localizer MRI images may include three-plane localizers used for scan planning, such as sagittal, coronal, and axial views. These localizer images are typically acquired at the beginning of a prostate MRI examination and serve as the basis for subsequent scan planning. In another embodiment, the initial localizer MRI images may be acquired immediately before the DWI acquisition to minimize the impact of gas movement due to natural peristalsis, as gas that was not present during initial localizer scans may move into the rectum during subsequent sequences.

At operation 304, the method includes segmenting a prostate gland in the localizer MRI images to create a prostate segmentation mask. In one embodiment, the prostate gland segmentation may be performed using a deep learning-based model specifically developed for prostate segmentation on sagittal and coronal localizers. The segmentation model may output a binary mask identifying the prostate region within the localizer images. In another embodiment, the method may leverage existing prostate segmentation models, such as those used in automated scan planning systems, to identify the boundaries of the prostate gland.

At operation 306, the method includes determining a region of interest (ROI) around the prostate gland. In one embodiment, the ROI may be defined as extending a predetermined distance from the prostate segmentation mask in multiple directions, such as 50 mm superiorly, 20 mm inferiorly, 10 mm anteriorly, and 80 mm posteriorly. This ROI focuses the subsequent analysis on the area most likely to contain rectal gas that could affect DWI quality. In another embodiment, the ROI may be dynamically determined based on the size and position of the prostate gland, adjusting the extension distances proportionally to ensure adequate coverage of the rectal area adjacent to the prostate.

At operation 308, the method includes applying contrast normalization to standardize the localizer MRI images. In one embodiment, the contrast normalization may be performed using a standardized contrast normalization (SCNe) technique to remove radiofrequency (RF) bias in the localizer data and standardize the threshold for subsequent segmentation steps. This normalization helps ensure consistent performance across different scanning protocols and equipment. In another embodiment, the contrast normalization may include histogram equalization or other intensity standardization techniques to account for variations in image acquisition parameters.

At operation 310, the method includes segmenting rectal gas regions within the ROI around the prostate gland. In one embodiment, the gas regions may be identified by applying a threshold to the normalized signal intensity, where pixels with normalized intensity below a certain threshold (e.g., 0.3 times the average prostate signal intensity) are classified as gas. This approach leverages the characteristic appearance of gas as hypointense (dark) regions in MRI. In another embodiment, a convolutional neural network (CNN) may be employed to perform the gas segmentation, potentially providing improved resilience to segmentation errors and better adaptation to various image characteristics.

At operation 312, the method includes selectively filtering the segmented rectal gas regions. In one embodiment, post-processing may be applied to remove regions smaller than a pre-determined number of pixels or voxels (e.g., 100 voxels), as these small regions are less likely to cause significant DWI distortion and may represent noise or segmentation errors. This filtering step helps focus the analysis on gas pockets large enough to potentially impact image quality. In another embodiment, morphological operations such as erosion and dilation may be applied to refine the gas region boundaries and connect nearby gas pockets that likely represent a single continuous gas region.

At operation 314, the method includes calculating morphological parameters based on the prostate segmentation mask and the rectal gas region segmentation masks. In one embodiment, the morphological parameters may include the minimum surface distance between the gas regions and the prostate gland, calculated using distance transform techniques such as the Hausdorff distance. Additionally, the total gas volume within the ROI may be calculated by summing the volumes of all identified gas regions. In another embodiment, additional morphological parameters may be calculated, such as the shape and orientation of gas pockets relative to the prostate, or the percentage of the prostate's posterior surface that is adjacent to gas.

At operation 316, the method includes determining acquisition parameters for the DWI sequence. In one embodiment, the acquisition parameters may include echo spacing, phase encoding lines, B₀ inhomogeneity, field strength, acquisition scheme (e.g., single-shot EPI, FOCUS, multi-shot), phase-encode direction, and parallel imaging factor. These parameters significantly influence the susceptibility of DWI sequences to distortion from rectal gas. In another embodiment, the acquisition parameters may be retrieved automatically from the MRI scanner's protocol settings, ensuring that the prediction model uses the actual parameters that will be employed for the upcoming DWI acquisition.

At operation 318, the method includes predicting a DWI distortion probability based on the morphological parameters and the acquisition parameters. In one embodiment, a multivariate logistic regression model may be used to predict the probability of DWI distortion, with the model trained on a dataset of cases with known DWI distortion outcomes. The model may use inputs such as minimum surface distance between gas and prostate (BDmin) and total gas volume (GasVol_cc), with a formula such as: DWI_Distortion_Prediction=0.991−0.076*BDmin+0.068*GasVol_cc. In another embodiment, a machine learning model, such as a random forest or neural network, may be employed to capture non-linear relationships between the input parameters and the likelihood of distortion.

At operation 320, the method includes determining if the predicted probability exceeds a threshold value. In one embodiment, the threshold may be determined through receiver operating characteristic (ROC) analysis of the prediction model's performance on a validation dataset, with a cutoff value (e.g., >0.52) selected to balance sensitivity and specificity. This threshold represents the point at which intervention is warranted to prevent poor image quality. In another embodiment, the threshold may be adjustable based on the specific clinical context or institutional preferences, allowing for customization of the system's sensitivity.

At operation 322, if the predicted probability does not exceed the threshold value (NO path from decision 320), the method includes proceeding with standard DWI acquisition. In one embodiment, the system may proceed with the planned DWI acquisition using the default protocol parameters, as the risk of significant artifacts is deemed acceptably low. This allows the workflow to continue without interruption when the analysis indicates that rectal gas is unlikely to cause problematic distortion in the DWI images. In another embodiment, the system may still display information about the detected gas to the technologist, but without an urgent alert, allowing the technologist to make an informed decision about whether to proceed with the standard acquisition or make optional adjustments.

At operation 324, if the predicted probability exceeds the threshold value (YES path from decision 320), the method includes generating an alert to the technologist about potential DWI artifacts. In one embodiment, the alert may be displayed prominently on the scanner console, highlighting the areas of rectal gas on the localizer images and indicating the high probability of DWI distortion. The alert may include specific information about the gas volume and its proximity to the prostate to help the technologist understand the severity of the potential issue. In another embodiment, the alert may be integrated into the scanner workflow, requiring acknowledgment from the technologist before proceeding with the DWI acquisition.

At operation 326, following the alert generation, the method includes suggesting optimization of scan parameters to mitigate the potential artifacts. In one embodiment, the system may suggest patient preparation measures such as administering a micro-enema to reduce rectal gas before proceeding with the scan. Alternatively, the system may suggest switching to a more robust DWI acquisition scheme, such as PROPELLER diffusion-weighted imaging, which is less susceptible to susceptibility artifacts. In another embodiment, the system may provide multiple optimization options with their estimated effectiveness, allowing the technologist to select the most appropriate intervention based on the specific clinical situation and available resources.

The method 300 described above provides several technical benefits over conventional approaches. By automatically detecting and analyzing rectal gas before DWI acquisition, the system enables technologists to take corrective action through patient preparation or DWI acquisition parameter adjustments, reducing the need for repeat examinations. This automated approach eliminates reliance on human judgment and experience, providing consistent assessment of potential DWI distortion across different operators and facilities. Furthermore, by analyzing both morphological parameters (such as gas volume and distance from prostate) and acquisition parameters, the system provides a more accurate prediction of potential artifacts than visual inspection alone. The method 300 also addresses the issue of gas movement during examination by enabling DWI acquisition immediately after localizer scans when used with automated scan planning systems. This ultimately improves workflow efficiency, enhances the diagnostic quality of prostate MRI studies, and increases the likelihood that DWI sequences will be of sufficient quality to facilitate proper reading and risk scoring according to PI-RADS guidelines.

Referring to FIG. 4, a flowchart of a method 400 for segmenting rectal gas regions in MRI images is shown. The method 400 provides an automated approach for detecting and segmenting rectal gas regions within a region of interest around a prostate gland in magnetic resonance imaging (MRI) images. The method 400 begins with receiving localizer MRI images and proceeds through various processing steps to identify and segment rectal gas regions, ultimately providing segmented rectal gas region masks that can be used for subsequent analysis of potential diffusion-weighted imaging (DWI) distortion.

At operation 402, the method includes receiving localizer MRI images of a subject. In one embodiment, the localizer MRI images may include three-plane localizers used for scan planning, such as sagittal, coronal, and axial views. These localizer images are typically acquired at the beginning of a prostate MRI examination and serve as the basis for subsequent scan planning and analysis. In another embodiment, the localizer MRI images may be acquired immediately before the DWI acquisition to minimize the impact of gas movement due to natural peristalsis, as gas that was not present during initial localizer scans may move into the rectum during subsequent sequences, potentially affecting DWI quality.

At operation 404, the method includes applying standardized contrast normalization (SCNe) to standardize the localizer MRI images. In one embodiment, the contrast normalization may be performed using the SCNe technique to remove radiofrequency (RF) bias in the localizer data and standardize the threshold for subsequent segmentation steps. This normalization helps ensure consistent performance across different scanning protocols and equipment by standardizing the image intensity values. In another embodiment, the contrast normalization may include histogram equalization or other intensity standardization techniques to account for variations in image acquisition parameters, ensuring that the subsequent thresholding operations can be performed consistently regardless of the original image contrast characteristics.

At operation 406, the method includes determining a region of interest (ROI) around the prostate gland. In one embodiment, the ROI may be defined as extending a predetermined distance from a prostate segmentation mask in multiple directions, such as 50 mm superiorly, 20 mm inferiorly, 10 mm anteriorly, and 80 mm posteriorly. This ROI focuses the subsequent analysis on the area most likely to contain rectal gas that could affect DWI quality. In another embodiment, the ROI may be dynamically determined based on the size and position of the prostate gland, adjusting the extension distances proportionally to ensure adequate coverage of the rectal area adjacent to the prostate while minimizing computational requirements by excluding irrelevant regions.

At operation 408, the method includes calculating an average signal intensity in the ROI around the prostate gland. In one embodiment, the average signal intensity may be calculated by summing the normalized signal intensities of all pixels within the ROI (which includes both the prostate and surrounding tissues) and dividing by the total number of pixels in the ROI. This average value serves as a reference for determining the threshold for gas segmentation in subsequent steps. In another embodiment, the average signal intensity may be calculated using a weighted approach that gives more importance to regions within the ROI that are more likely to be affected by rectal gas-induced artifacts in DWI sequences, such as the posterior region adjacent to the rectum.

At operation 410, the method includes setting a gas threshold based on the average signal intensity determined at operation 408. In one embodiment, the gas threshold may be set as a fixed proportion of the average prostate ROI signal intensity, such as 0.3 times the average intensity. This approach leverages the characteristic appearance of gas as hypointense (dark) regions in MRI relative to the prostate tissue. In another embodiment, the gas threshold may be adaptively determined based on both the average prostate signal intensity and the overall image histogram, allowing for more robust segmentation across different scanning parameters and patient anatomies.

At operation 412, the method includes identifying all pixels within the ROI having normalized signal intensity below the gas threshold. In one embodiment, a binary mask may be created where pixels with normalized intensity below the threshold are assigned a value of 1 (indicating gas) and all other pixels are assigned a value of 0. This binary segmentation approach provides a clear delineation between gas regions and surrounding tissues. In another embodiment, a probabilistic approach may be used where each pixel is assigned a probability of being gas based on its distance from the threshold value, allowing for more nuanced segmentation in boundary regions where partial volume effects may occur.

At operation 414, the method includes applying post-processing to remove small regions of segmented gas that are smaller than a pre-determined number of pixels/voxels. In one embodiment, connected component analysis may be performed on the binary gas mask, and segmented gas regions smaller than a pre-determined size (e.g., 100 voxels) are removed, as these small gas regions are less likely to cause significant DWI distortion and may represent noise or segmentation errors. This filtering step helps focus the analysis on gas pockets large enough to potentially impact image quality. In another embodiment, morphological operations such as erosion and dilation may be applied to refine the gas region boundaries and connect nearby gas pockets that likely represent a single continuous gas region, improving the anatomical accuracy of the segmentation.

At operation 416, the method includes outputting segmented rectal gas regions. In one embodiment, the output may be in the form of a binary mask identifying the locations of rectal gas within the ROI around the prostate. This mask can then be used for subsequent analysis, such as calculating morphological parameters like minimum surface distance between gas and prostate or total gas volume. In another embodiment, the output may include both the binary mask and quantitative measurements of the segmented gas regions, such as volume, distance from the prostate, and shape characteristics, which can be directly used to predict the probability of DWI distortion.

The method 400 described above provides several technical benefits over conventional approaches. By automatically detecting and segmenting rectal gas regions in localizer MRI images, the method enables subsequent analysis of the potential impact on DWI quality without requiring manual intervention. The use of contrast normalization ensures consistent performance across different scanning protocols and equipment, while the ROI-based approach focuses computational resources on the relevant anatomical region, thereby optimizing processing efficiency. The adaptive thresholding based on prostate ROI signal intensity accounts for variations in image acquisition parameters with minimal computational complexity, and the post-processing steps help eliminate false positives and improve segmentation accuracy through efficient connected component analysis. This automated approach eliminates reliance on human judgment and experience, providing consistent assessment of rectal gas presence across different operators and facilities, while simultaneously reducing computational demands through targeted analysis of only the most relevant image regions and use of computationally efficient threshold based segmentation of gas regions. The selective filtering of small gas regions further streamlines the computational pipeline by removing regions unlikely to cause significant DWI distortion, ultimately contributing to improved workflow efficiency, reduced processing time, and enhanced diagnostic quality of prostate MRI studies.

Referring to FIG. 5, a flowchart of a method 500 for generating input features for a predictive model using prostate and gas region data is shown. The method 500 provides an automated approach for calculating morphological parameters based on prostate segmentation masks and rectal gas region segmentation masks, and encoding these parameters along with acquisition parameters as input features for a predictive model. The predictive model may be used to predict the probability of DWI distortion due to rectal gas, enabling technologists to take corrective action before DWI acquisition. The method 500 begins with receiving segmented data and proceeds through various processing steps to generate input features for the predictive model.

At operation 502, the method includes receiving a segmented prostate mask and segmented gas regions. In one embodiment, the segmented prostate mask may be generated using a deep learning-based model specifically developed for prostate segmentation on sagittal and coronal localizers. The segmentation model may output a binary mask identifying the prostate region within the localizer images. In another embodiment, the method may leverage existing prostate segmentation models, such as those used in automated scan planning systems, to identify the boundaries of the prostate gland. The segmented gas regions may be generated through the process described in FIG. 4, which includes applying contrast normalization, determining a ROI around the prostate, calculating average signal intensity, setting a gas threshold, identifying pixels below the threshold, and applying post-processing to remove small regions.

At operation 504, the method includes calculating a minimum surface distance between the segmented rectal gas regions and the prostate gland. In one embodiment, the minimum surface distance may be calculated using distance transform techniques such as the Hausdorff distance, which measures the maximum distance one would need to travel from a point in one set to the closest point in another set. This distance metric provides a quantitative measure of how close the gas pockets are to the prostate, which is a factor in determining the likelihood of susceptibility artifacts in DWI.

At operation 506, the method includes calculating the total gas volume within the ROI around the prostate. In one embodiment, the total gas volume may be calculated by summing the volumes of all identified gas regions within the ROI, with the volume expressed in cubic centimeters. This calculation provides a quantitative measure of the amount of gas present near the prostate, which is another relevant factor in determining the likelihood of susceptibility artifacts in DWI. In another embodiment, the gas volume calculation may include additional processing to account for partial volume effects at the boundaries of gas regions, providing a more accurate estimate of the total gas volume.

At operation 508, the method includes retrieving acquisition parameters for the DWI sequence. In one embodiment, the acquisition parameters may include echo spacing, phase encoding lines, B₀ inhomogeneity, field strength, acquisition scheme (e.g., single-shot EPI, FOCUS, multi-shot), phase-encode direction, and parallel imaging factor. These parameters significantly influence the susceptibility of DWI sequences to distortion from rectal gas. In another embodiment, the acquisition parameters may be retrieved automatically from the MRI scanner's protocol settings, ensuring that the prediction model uses the actual parameters that will be employed for the upcoming DWI acquisition.

At operation 510, the method includes encoding the morphological parameters and acquisition parameters as input features of a predictive model. In one embodiment, the morphological parameters (minimum surface distance and total gas volume) and acquisition parameters may be encoded as input features for a multivariate logistic regression model that predicts the probability of DWI distortion. The logistic regression model may be trained on a dataset of cases with known DWI distortion outcomes, with a formula such as: DWI_Distortion_Prediction=0.991−0.076*BDmin+0.068*GasVol_cc. In another embodiment, the encoded parameters may serve as input features for a machine learning model, such as a random forest or neural network, which may be able to capture non-linear relationships between the input parameters and the likelihood of distortion.

The method 500 described above provides several technical benefits over conventional approaches. By calculating the minimum surface distance between gas and prostate using distance transform techniques such as the Hausdorff distance, the method enables precise quantification of spatial proximity between these structures, which is a primary determinant of susceptibility artifacts. Similarly, the calculation of total gas volume within a specifically defined ROI around the prostate provides a targeted measurement of gas presence in the most relevant anatomical region, rather than considering all gas in the field of view. The encoding of these specific morphological parameters, along with acquisition parameters such as echo spacing, phase encoding lines, B₀ inhomogeneity, field strength, and acquisition scheme, creates a comprehensive feature set that captures the most salient parameters effecting susceptibility artifact formation. This selection of parameters accounts for both the physical proximity of gas to the prostate and the total gas burden, which together with the acquisition parameters, determine the severity of susceptibility artifacts in DWI sequences.

Referring to FIG. 6, a flowchart of a method 600 for managing MRI scan protocols based on gas analysis and distortion probability is shown. The method 600 provides an automated approach for alerting technologists about potential diffusion-DWI artifacts due to rectal gas and facilitating appropriate interventions to optimize scan quality. The method 600 begins with receiving DWI distortion probability and gas analysis results and proceeds through various steps to update scan protocols based on technologist-selected interventions.

At operation 602, the method includes receiving DWI distortion probability and gas analysis results. In one embodiment, the DWI distortion probability may be generated by a distortion prediction model that analyzes morphological parameters (such as minimum surface distance between gas and prostate and total gas volume) and acquisition parameters (such as echo spacing, phase encoding lines, and field strength). The gas analysis results may include segmented rectal gas regions within a region of interest (ROI) around the prostate gland, calculated using the methods described in connection with FIG. 4. In another embodiment, the DWI distortion probability may be received from a multivariate logistic regression model trained on a dataset of cases with known DWI distortion outcomes.

At operation 604, the method includes displaying an alert on the scanner console showing gas regions highlighted on localizer images, gas volume measurements, distance from prostate, and predicted distortion probability. In one embodiment, the alert may be displayed prominently on the scanner console when the predicted DWI distortion probability exceeds a threshold value (e.g., >0.52), with the gas regions highlighted in a contrasting color on the localizer images to clearly indicate their location relative to the prostate. The alert may include specific quantitative information about the gas volume and its minimum distance from the prostate to help the technologist understand the severity of the potential issue. In another embodiment, the alert may include a visual representation of the predicted distortion probability, such as a gauge or meter that indicates the likelihood of significant artifacts in the upcoming DWI acquisition, with color coding (e.g., green for low probability, yellow for moderate probability, and red for high probability) to facilitate quick interpretation by the technologist.

At operation 606, the method includes presenting intervention options to the technologist. In one embodiment, the intervention options may include patient preparation measures such as administering a micro-enema to reduce rectal gas before proceeding with the scan, repositioning the patient to potentially shift the gas away from the prostate, or switching to a more robust DWI acquisition scheme, such as PROPELLER diffusion-weighted imaging, which is less susceptible to susceptibility artifacts. Each option may be presented with an estimated effectiveness and time requirement to help the technologist make an informed decision. In another embodiment, the intervention options may be dynamically generated based on the specific characteristics of the detected gas, with the system recommending the most appropriate intervention based on factors such as gas volume, proximity to the prostate, and available acquisition protocols at the specific facility.

At operation 608, the method includes waiting for technologist acknowledgment and selection. In one embodiment, the system may require explicit acknowledgment from the technologist before proceeding with the DWI acquisition, ensuring that the potential issue is addressed rather than overlooked. The technologist may select one of the presented intervention options using the scanner console interface, or may choose to proceed with the standard acquisition despite the warning if clinical judgment suggests that the artifacts may not significantly impact diagnostic quality. In another embodiment, the system may implement a timeout feature that automatically selects a default intervention option if no selection is made within a predetermined time period, balancing the need for technologist input with workflow efficiency considerations.

At operation 610, the method includes logging the selected intervention and timestamp. In one embodiment, the system may record the technologist's selection, along with the timestamp, gas analysis results, and predicted distortion probability, in a structured log that can be reviewed later for quality assurance and process improvement purposes. This logging functionality enables facilities to track the frequency of rectal gas-related issues and the effectiveness of various interventions over time. In another embodiment, the logged information may be automatically incorporated into the radiology report as a technical note, informing the interpreting radiologist about potential image quality issues and the steps taken to address them, which may be valuable context for image interpretation.

At operation 612, the method includes updating the scan protocol based on the selected intervention. In one embodiment, if the technologist selects an alternative acquisition scheme (such as PROPELLER DWI), the system may automatically update the scan protocol parameters accordingly, ensuring that the appropriate sequence is used without requiring manual parameter adjustments by the technologist. If patient preparation measures are selected, the system may pause the scan queue to allow time for the intervention to be performed before resuming with the standard protocol. In another embodiment, the system may implement adaptive protocol adjustments based on the specific characteristics of the detected gas, such as modifying the phase-encode direction to minimize the impact of susceptibility artifacts or adjusting parallel imaging factors to reduce distortion while maintaining adequate signal-to-noise ratio.

Referring to FIG. 7, a visual representation of a contrast normalization process for enhancing medical images is shown. The figure demonstrates the transformation from an initial medical image 702 to a contrast-normalized medical image 704 through the application of a contrast normalization process 706. The initial medical image 702 and the contrast-normalized medical image 704 are sagittal views of a pelvic region, which may be used for detecting and analyzing rectal gas impact on diffusion-weighted imaging (DWI) quality in prostate MRI examinations.

The initial medical image 702 is a localizer MRI image acquired during scan planning of a subject. In one embodiment, the initial medical image 702 may be a sagittal localizer image obtained at the beginning of a prostate MRI examination, showing anatomical structures including the prostate gland, rectum, and surrounding tissues with relatively low contrast between different tissue types. In another embodiment, the initial medical image 702 may be acquired immediately before DWI acquisition to minimize the impact of gas movement due to natural peristalsis, as gas that was not present during initial localizer scans may move into the rectum during subsequent sequences. The initial medical image 702 typically exhibits radiofrequency (RF) bias and non-standardized intensity values, which may complicate subsequent segmentation and analysis steps for detecting rectal gas regions that could potentially affect DWI image quality.

The contrast normalization process 706 applies standardized contrast normalization (SCNe) to the initial medical image 702 to remove radiofrequency bias and standardize image intensity values. In one embodiment, the contrast normalization process 706 may be performed as part of an automated workflow that includes prostate gland segmentation, region of interest (ROI) determination, and rectal gas detection. In another embodiment, the contrast normalization process 706 may include histogram equalization or other intensity standardization techniques to account for variations in image acquisition parameters. The contrast normalization process 706 helps ensure consistent performance across different scanning protocols and equipment by standardizing the image intensity values, which is beneficial for the subsequent thresholding operations used to identify rectal gas regions. This process may be implemented using one or more processors executing instructions stored in non-transitory memory of an image processing device, such as the image processing device shown in FIG. 2.

The contrast-normalized medical image 704 is the output of the contrast normalization process 706, showing enhanced contrast and standardized intensity values. In one embodiment, the contrast-normalized medical image 704 may be used directly for subsequent processing steps, including determining an ROI around the prostate gland, calculating average signal intensity in the prostate region, setting a gas threshold based on the average prostate signal intensity, and identifying pixels within the ROI having normalized signal intensity below the threshold to segment rectal gas regions. In another embodiment, the contrast-normalized medical image 704 may be displayed to a technologist alongside segmentation results to provide visual confirmation of the detected rectal gas regions. The enhanced contrast in the contrast-normalized medical image 704 improves the visibility of anatomical structures and tissue boundaries, facilitating more accurate segmentation of both the prostate gland and rectal gas regions.

By standardizing image intensity values, the contrast normalization process 706 enables more reliable thresholding for gas segmentation, where pixels with normalized intensity below a certain threshold may be classified as gas. This approach leverages the characteristic appearance of gas as hypointense (dark) regions in MRI relative to the prostate tissue. The contrast normalization process 706 connects to subsequent processing steps, including gas segmentation, morphological parameter calculation, and DWI distortion probability prediction, forming an integrated workflow for automatically detecting and analyzing rectal gas before DWI acquisition to enable timely intervention and optimization of scan parameters.

Referring to FIG. 8, a visualization of a prostate segmentation process showing the transformation from an input medical image to a segmented output image is shown. The figure demonstrates the transformation from an initial medical image 802 to a segmented medical image 804 through the application of a prostate segmentation process 806. The initial medical image 802 and the segmented medical image 804 are localizer MRI images of a pelvic region, which may be used for detecting and analyzing rectal gas impact on DWI quality in prostate MRI examinations.

The initial medical image 802 is a localizer MRI image acquired during scan planning of a subject. In one embodiment, the initial medical image 802 may be a sagittal localizer image obtained at the beginning of a prostate MRI examination, showing anatomical structures including the prostate gland, rectum, and surrounding tissues. In another embodiment, the initial medical image 802 may be acquired immediately before DWI acquisition to minimize the impact of gas movement due to natural peristalsis, as gas that was not present during initial localizer scans may move into the rectum during subsequent sequences.

The prostate segmentation process 806 applies a deep learning-based model to the initial medical image 802 to identify and segment the prostate gland. In one embodiment, the prostate segmentation process 806 may be performed by the prostate gland segmentation module 208 as part of an automated workflow that includes region of interest (ROI) determination, gas segmentation, and rectal gas detection. In another embodiment, the prostate segmentation process 806 may leverage existing prostate segmentation models, such as those used in automated scan planning systems, to identify the boundaries of the prostate gland. The prostate segmentation process 806 helps ensure accurate delineation of the prostate boundaries, which is beneficial for the subsequent determination of an ROI around the prostate and for calculating morphological parameters such as the minimum surface distance between rectal gas and the prostate.

The segmented medical image 804 is the output of the prostate segmentation process 806, showing the prostate gland highlighted with a colored overlay on the original image. In one embodiment, the segmented medical image 804 may include a binary mask identifying the prostate region within the localizer images, which is then used for subsequent processing steps, including determining an ROI around the prostate gland, segmenting rectal gas regions within this ROI, and calculating morphological parameters based on the spatial relationship between the prostate and any detected rectal gas. In another embodiment, the segmented medical image 804 may be displayed to a technologist alongside gas segmentation results to provide visual confirmation of the anatomical relationships between the prostate and detected rectal gas regions. By accurately segmenting the prostate gland, the prostate segmentation process 806 enables more precise determination of the ROI around the prostate, which focuses subsequent gas segmentation and analysis on the area most likely to contain rectal gas that could affect DWI quality.

Referring to FIG. 9, a comparison of anatomical scan images before and after gas segmentation processing is shown. The figure demonstrates a visual representation of a gas segmentation process for detecting rectal gas that may cause susceptibility artifacts in DWI of the prostate. The figure includes an original anatomical scan image 902, a processed anatomical scan image with gas segmentation 904, and a gas segmentation process 906 connecting images 902 and 904.

The original anatomical scan image 902 is a sagittal localizer MRI image acquired during scan planning of a subject. In one embodiment, the original anatomical scan image 902 may be a sagittal localizer image obtained at the beginning of a prostate MRI examination, showing anatomical structures including the prostate gland, rectum, and surrounding tissues. In another embodiment, the original anatomical scan image 902 may be acquired immediately before DWI acquisition to minimize the impact of gas movement due to natural peristalsis, as gas that was not present during initial localizer scans may move into the rectum during subsequent sequences. The original anatomical scan image 902 typically exhibits RF bias and non-standardized intensity values, which may complicate subsequent segmentation and analysis steps for detecting rectal gas regions that could potentially affect DWI image quality.

The gas segmentation process 906 applies standardized contrast normalization (SCNe) to the original anatomical scan image 902 to remove radiofrequency bias and standardize image intensity values. In one embodiment, the gas segmentation process 906 may include identifying pixels within a region of interest (ROI) around the prostate gland having normalized signal intensity below a predetermined threshold, where the threshold is set as a proportion of the average signal intensity in the prostate region. This approach leverages the characteristic appearance of gas as hypointense (dark) regions in MRI relative to the prostate tissue. In another embodiment, the gas segmentation process 906 may employ a CNN to perform the gas segmentation, potentially providing improved resilience to segmentation errors and better adaptation to various image characteristics. The gas segmentation process 906 may also include post-processing steps to remove regions smaller than a pre-determined number of pixels or voxels (e.g., 100 voxels), as these small regions are less likely to cause significant DWI distortion and may represent noise or segmentation errors.

The processed anatomical scan image 904 is the output of the gas segmentation process 906, showing enhanced contrast and segmented gas regions. In one embodiment, the processed anatomical scan image 904 may include highlighted regions representing segmented rectal gas pockets that could potentially cause susceptibility artifacts in DWI sequences. In another embodiment, the processed anatomical scan image 904 may be used for subsequent processing steps, including calculating morphological parameters such as minimum surface distance between gas and prostate or total gas volume, which can be used to predict the probability of DWI distortion. The enhanced contrast in the processed anatomical scan image 904 improves the visibility of anatomical structures and tissue boundaries, facilitating more accurate segmentation of both the prostate gland and rectal gas regions.

Referring to FIG. 10, a medical imaging visualization showing ROI selection is shown. The visualization includes a full anatomical view image 1002 containing a highlighted ROI selection 1006, which is shown in greater detail in magnified ROI view 1004.

The full anatomical view image 1002 may be a localizer MRI image acquired during a prostate MRI examination. In one embodiment, the full anatomical view image 1002 may be a sagittal localizer image showing the pelvic region including the prostate gland and surrounding anatomical structures. In another embodiment, the full anatomical view image 1002 may be an axial T2-weighted image obtained prior to DWI acquisition. The full anatomical view image 1002 may be processed using a contrast normalization technique, such as SCNe, to standardize image intensity across different acquisitions and remove RF bias in the localizer data, thereby enabling more consistent threshold-based segmentation of anatomical structures.

The ROI selection 1006 identifies a specific region around the prostate gland for detailed analysis. In one embodiment, the ROI selection 1006 may be automatically determined by the ROI determination module 210 based on the prostate gland segmentation performed by the prostate gland segmentation module 208. The ROI selection 1006 may extend a predetermined distance from the prostate mask. In another embodiment, the ROI selection 1006 may be manually defined by a user through a user input device 222. The ROI selection 1006 serves as a boundary within which rectal gas regions are identified and analyzed to determine their potential impact on DWI image quality.

The magnified ROI view 1004 provides an enlarged visualization of the area defined by ROI selection 1006. In one embodiment, the magnified ROI view 1004 may display the segmented prostate gland in one color and any detected rectal gas regions in another color. In another embodiment, the magnified ROI view 1004 may include overlay information showing the minimum surface distance between the prostate gland and the nearest rectal gas pocket. The magnified ROI view 1004 may also display calculated morphological parameters, such as the minimum boundary distance (BDmin) between the gas pocket and prostate gland, and the total gas volume within the ROI. These parameters are used by the distortion prediction model 218 to calculate the probability of DWI distortion occurring due to the presence of rectal gas.

The disclosure also provides support for a method, comprising: acquiring localizer magnetic resonance imaging (MRI) images of a subject, segmenting an organ in the localizer MRI images to create an organ segmentation mask, determining a region of interest (ROI) around the organ, applying contrast normalization to standardize the localizer MRI images, segmenting gas regions within the ROI around the organ, calculating morphological parameters based on the organ segmentation mask and the gas regions, determining acquisition parameters for diffusion-weighted imaging (DWI), predicting a DWI distortion probability based on the morphological parameters and the acquisition parameters, generating an alert to a technologist about potential DWI artifacts when the DWI distortion probability exceeds a threshold value, automatically adjusting scan parameters when the DWO distortion probability exceeds the threshold value, and acquiring a medical image based on the adjusted scan parameters. In a first example of the method, segmenting gas regions comprises: calculating an average signal intensity in the ROI around the organ, setting a gas threshold based on the average signal intensity, identifying pixels within the ROI having normalized signal intensity below the gas threshold, and applying post-processing to remove regions smaller than a pre-determined number of pixels. In a second example of the method, optionally including the first example, calculating morphological parameters comprises: calculating a minimum surface distance between the segmented gas regions and the organ, and calculating a total gas volume within the ROI around the organ. In a third example of the method, optionally including one or both of the first and second examples, predicting the DWI distortion probability comprises inputting the morphological parameters and the acquisition parameters into a logistic regression model. In a fourth example of the method, optionally including one or more or each of the first through third examples, the logistic regression model is trained using a plurality of training cases with known DWI distortion outcomes. In a fifth example of the method, optionally including one or more or each of the first through fourth examples, determining the ROI around the organ comprises defining a region extending a predetermined distance superiorly, inferiorly, anteriorly, and posteriorly from the organ segmentation mask. In a sixth example of the method, optionally including one or more or each of the first through fifth examples, the acquisition parameters comprise at least one of: echo spacing, phase encoding lines, B0 inhomogeneity, field strength, acquisition scheme, phase-encode direction, and parallel imaging factor. In a seventh example of the method, optionally including one or more or each of the first through sixth examples, the method further comprises: suggesting optimization of scan parameters when the DWI distortion probability exceeds the threshold value.

The disclosure also provides support for a system, comprising: one or more processors, and non-transitory memory storing instructions executable by the one or more processors to: obtain initial localizer magnetic resonance imaging (MRI) images of a subject, segment a prostate gland in the initial localizer MRI images, determine a region of interest (ROI) around the segmented prostate gland, apply contrast normalization to standardize the initial localizer MRI images, segment rectal gas regions within the ROI around the prostate gland, selectively filter the segmented rectal gas regions, calculate morphological parameters based on the segmented prostate gland and the segmented rectal gas regions, determine acquisition parameters for diffusion-weighted imaging (DWI), predict a DWI distortion probability based on the morphological parameters and the acquisition parameters, and generate an alert to a technologist when the predicted DWI distortion probability exceeds a threshold value. In a first example of the system, the instructions to segment rectal gas regions comprise instructions to: calculate an average signal intensity in the segmented prostate gland, set a gas threshold based on the average signal intensity in the segmented prostate gland, and identify pixels within the ROI having a normalized signal intensity below the gas threshold. In a second example of the system, optionally including the first example, the instructions to selectively filter the segmented rectal gas regions comprise instructions to remove regions smaller than a pre-determined number of pixels. In a third example of the system, optionally including one or both of the first and second examples, the morphological parameters include a minimum surface distance between the segmented rectal gas regions and the segmented prostate gland and a total gas volume within the ROI. In a fourth example of the system, optionally including one or more or each of the first through third examples, the instructions to calculate the minimum surface distance comprise instructions to use a Hausdorff distance filter. In a fifth example of the system, optionally including one or more or each of the first through fourth examples, the instructions to predict the DWI distortion probability comprise instructions to: encode the morphological parameters and the acquisition parameters as input features to a predictive model, and apply a logistic regression model to the input features to generate the DWI distortion probability. In a sixth example of the system, optionally including one or more or each of the first through fifth examples, the logistic regression model is trained using a plurality of training cases, each training case including a set of morphological parameters, acquisition parameters, and a corresponding label indicating whether DWI distortion occurred. In a seventh example of the system, optionally including one or more or each of the first through sixth examples, the instructions further comprise instructions to: suggest adjustment of scan parameters in response to the predicted DWI distortion probability exceeding the threshold value.

The disclosure also provides support for a method for predicting diffusion-weighted imaging (DWI) distortion in prostate magnetic resonance imaging (MRI), comprising: acquiring localizer MRI images of a subject, segmenting a prostate gland in the localizer MRI images using a deep learning-based model to create a prostate segmentation mask, determining a region of interest (ROI) extending a predetermined distance from the prostate segmentation mask in multiple directions, applying contrast normalization to remove radiofrequency bias in the localizer MRI images, calculating an average signal intensity in the ROI around the prostate gland, setting a gas threshold as a proportion of the average signal intensity, identifying pixels within the ROI having normalized signal intensity below the gas threshold to create a binary gas mask, applying connected component analysis to remove gas regions smaller than a pre-determined size, calculating a minimum surface distance between remaining gas regions and the prostate gland, calculating a total gas volume within the ROI, retrieving acquisition parameters for a planned DWI sequence, encoding the minimum surface distance, the total gas volume, and the acquisition parameters as input features for a predictive model, applying the predictive model to generate a probability of DWI distortion, and displaying an alert on a display device when the probability of DWI distortion exceeds a threshold value. In a first example of the method, the method further comprises: in response to the probability of DWI distortion exceeding the threshold value: displaying the remaining gas regions on the display device, and suggesting an alternative DWI acquisition scheme that is less susceptible to susceptibility artifacts. In a second example of the method, optionally including the first example, predicting the probability of DWI distortion comprises applying a statistical model that correlates the minimum surface distance, the total gas volume, and the acquisition parameters with known DWI distortion outcomes from a training dataset. In a third example of the method, optionally including one or both of the first and second examples, the predictive model comprises a multivariate logistic regression model trained on a dataset of cases with known DWI distortion outcomes.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A method, comprising:
acquiring localizer magnetic resonance imaging (MRI) images of a subject;
segmenting an organ in the localizer MRI images to create an organ segmentation mask;
determining a region of interest (ROI) around the organ;
applying contrast normalization to standardize the localizer MRI images;
segmenting gas regions within the ROI around the organ;
calculating morphological parameters based on the organ segmentation mask and the gas regions;
determining acquisition parameters for diffusion-weighted imaging (DWI);
predicting a DWI distortion probability based on the morphological parameters and the acquisition parameters;
generating an alert to a technologist about potential DWI artifacts when the DWI distortion probability exceeds a threshold value;
automatically adjusting scan parameters when the DWI distortion probability exceeds the threshold value; and
acquiring a medical image based on the adjusted scan parameters.

2. The method of claim 1, wherein segmenting gas regions comprises:
calculating an average signal intensity in the ROI around the organ;
setting a gas threshold based on the average signal intensity;
identifying pixels within the ROI having normalized signal intensity below the gas threshold; and
applying post-processing to remove regions smaller than a pre-determined number of pixels.

3. The method of claim 1, wherein calculating morphological parameters comprises:
calculating a minimum surface distance between the segmented gas regions and the organ; and
calculating a total gas volume within the ROI around the organ.

4. The method of claim 1, wherein predicting the DWI distortion probability comprises inputting the morphological parameters and the acquisition parameters into a logistic regression model.

5. The method of claim 4, wherein the logistic regression model is trained using a plurality of training cases with known DWI distortion outcomes.

6. The method of claim 1, wherein determining the ROI around the organ comprises defining a region extending a predetermined distance superiorly, inferiorly, anteriorly, and posteriorly from the organ segmentation mask.

7. The method of claim 1, wherein the acquisition parameters comprise at least one of:
echo spacing, phase encoding lines, B₀ inhomogeneity, field strength, acquisition scheme, phase-encode direction, and parallel imaging factor.

8. The method of claim 1, wherein the alert comprises suggested adjustments to scan parameters based on the DWI distortion probability.

9. A system, comprising:
one or more processors; and
non-transitory memory storing instructions executable by the one or more processors to:
obtain initial localizer magnetic resonance imaging (MRI) images of a subject;
segment a prostate gland in the initial localizer MRI images;
determine a region of interest (ROI) around the segmented prostate gland;
apply contrast normalization to standardize the initial localizer MRI images;
segment rectal gas regions within the ROI around the prostate gland;
selectively filter the segmented rectal gas regions;
calculate morphological parameters based on the segmented prostate gland and the segmented rectal gas regions;
determine acquisition parameters for diffusion-weighted imaging (DWI);
predict a DWI distortion probability based on the morphological parameters and the acquisition parameters; and
generate an alert to a technologist when the predicted DWI distortion probability exceeds a threshold value.

10. The system of claim 9, wherein the instructions to segment rectal gas regions comprise instructions to:
calculate an average signal intensity in the segmented prostate gland;
set a gas threshold based on the average signal intensity in the segmented prostate gland; and
identify pixels within the ROI having a normalized signal intensity below the gas threshold.

11. The system of claim 9, wherein the instructions to selectively filter the segmented rectal gas regions comprise instructions to remove regions smaller than a pre-determined number of pixels.

12. The system of claim 9, wherein the morphological parameters include a minimum surface distance between the segmented rectal gas regions and the segmented prostate gland and a total gas volume within the ROI.

13. The system of claim 12, wherein the instructions to calculate the minimum surface distance comprise instructions to use a Hausdorff distance filter.

14. The system of claim 9, wherein the instructions to predict the DWI distortion probability comprise instructions to:
encode the morphological parameters and the acquisition parameters as input features to a predictive model; and
apply a logistic regression model to the input features to generate the DWI distortion probability.

15. The system of claim 14, wherein the logistic regression model is trained using a plurality of training cases, each training case including a set of morphological parameters, acquisition parameters, and a corresponding label indicating whether DWI distortion occurred.

16. The system of claim 10, wherein the instructions further comprise instructions to:
suggest adjustment of scan parameters in response to the predicted DWI distortion probability exceeding the threshold value.

17. A method for predicting diffusion-weighted imaging (DWI) distortion in prostate magnetic resonance imaging (MRI), comprising:
acquiring localizer MRI images of a subject;
segmenting a prostate gland in the localizer MRI images using a deep learning-based model to create a prostate segmentation mask;
determining a region of interest (ROI) extending a predetermined distance from the prostate segmentation mask in multiple directions;
applying contrast normalization to remove radiofrequency bias in the localizer MRI images;
calculating an average signal intensity in the ROI around the prostate gland;
setting a gas threshold as a proportion of the average signal intensity;
identifying pixels within the ROI having normalized signal intensity below the gas threshold to create a binary gas mask;
applying connected component analysis to remove gas regions smaller than a pre-determined size;
calculating a minimum surface distance between remaining gas regions and the prostate gland;
calculating a total gas volume within the ROI;
retrieving acquisition parameters for a planned DWI sequence;
encoding the minimum surface distance, the total gas volume, and the acquisition parameters as input features for a predictive model;
applying the predictive model to generate a probability of DWI distortion; and
displaying an alert on a display device when the probability of DWI distortion exceeds a threshold value.

18. The method of claim 17, further comprising:
in response to the probability of DWI distortion exceeding the threshold value:
displaying the remaining gas regions on the display device; and
suggesting an alternative DWI acquisition scheme that is less susceptible to susceptibility artifacts.

19. The method of claim 17, wherein predicting the probability of DWI distortion comprises applying a statistical model that correlates the minimum surface distance, the total gas volume, and the acquisition parameters with known DWI distortion outcomes from a training dataset.

20. The method of claim 17, wherein the predictive model comprises a multivariate logistic regression model trained on a dataset of cases with known DWI distortion outcomes.
